(19) United States
(12) Patent Application Publication
(10) Pub. No.: US 2004/0077199 A1
(43) Pub. Date: Apr. 22, 2004

(54) Electrical connectivity through a hinge

(76) Inventors: Russell Winstead, Raleigh, NC (US); Charles Rudisill, Apex, NC (US)

Correspondence Address: BAKER & BOTTS, 30 ROCKEFELLER PLAZA, NEW YORK, NY, 10112

(21) Appl. No.: 10/618,483

(22) Filed: Jul. 11, 2003

Related U.S. Application Data
(63) Continuation-in-part of application No. 10/277,582, filed on Oct. 22, 2002.

(51) Int. Cl. H01R 3/00

(52) U.S. Cl. 439/165

(57) ABSTRACT

A hinge member provides electrical conductivity between pivotable bodies of an electronic device without the use of individual conductive wires, flexible conductive cables, bundles of wire, discrete connectors, or combinations thereof. The hinge member physically interconnects a first body to a pivotable second body of an electronic device, and includes a cylinder made in at least two portions and having circumferential grooves with three dimensional circuitry in the grooves and extending onto a mating surfaces of the two portions. Spring contacts connect to the three dimensional circuitry in the grooves and provide electrical connection to the first body.

This application is a continuation-in-part of co-pending application Ser. No. 10/277,582 filed Oct. 22, 2002, which is incorporated herein by reference.

### TECHNICAL FIELD OF THE INVENTION

The present invention relates to portable electronic devices which require electrical connectivity of one or more connections through hinged members, or other rotating subassemblies. In particular, the present invention relates to a system of providing connectivity of electrical components, located in different parts of an electronic device, through a hinged member which provides both electrical and physical interconnectivity.

### BACKGROUND

Today, many electronic devices include two or more parts joined at a hinge, or other movable type of joint. Some common devices that use electrical connections through a hinge include, for example, portable computers, wireless telephones, personal digital assistants (“PDA”), camcorders, flip-out display devices, microphones, and cameras.

Conventionally, these devices require the use of a wire or set of wires through the hinge for electrical conductivity. This requires the physical routing of individual conductive wires, flexible conductive cables, electrical coaxial cable(s), bundles of wire, or combinations of these through the hinged area(s). This results in a difficult assembly process, multiple connections with associated reliability problems and assembly difficulties, severe space limitations, costs, limited control of desired electrical impedance and other electrical properties, poor removability and serviceability, and mechanical considerations related to fatigue life due to the flexing of the electrical wires and conductors as the hinge is opened and closed repeatedly.

Thus, there is a need for a more reliable, and cost efficient solution to electrically connecting two or more portions of an electronic device through a hinge, or other movable part.

### SUMMARY OF THE INVENTION

In accordance with the invention there is provided a hinge member arranged to provide electrical connection between electrical circuits on a first body and electrical circuits on a second body pivotably mounted to the first body. A bracket is mounted on the first body. A cylinder having an axis is arranged to be mounted on the second body and pivot therewith. The cylinder is arranged to be rotatably received in the bracket and is formed in at least two cylinder portions having mating surfaces extending in the direction of the axis. The cylinder has a plurality of circumferential grooves and three dimensional electrical conductors in selected portions of the grooves. Each of the conductors extends onto at least one of the mating surfaces. Contact springs are rotatably received in at least some of the grooves and have ends extending into the bracket. The contact spring ends are arranged to connect to at least one circuit on the first body. At least one interconnection member is provided and received between the mating surfaces of the cylinder. The interconnection member is arranged to interconnect the three dimensional electrical conductors to at least one circuit on the second body.

In a preferred arrangement the cylinder is a circular cylinder and the mating surfaces are planar surfaces. The mating surfaces may be partially undercut with the conductors extending onto undercut portions of the mating surfaces. The conductors in alternate ones of the grooves may extend onto the mating surface of a first cylinder and the conductors in the remaining grooves extend onto the mating surfaces of a second cylinder portion. The cylinder may be received in the bracket at a first axial end and arranged to be mounted to the second body at a second axial end. Each of the contact springs may include a circular spring portion which is received in the grooves. The contact spring end may comprise a spring contact tail for connection to at least one circuit on the first body. The contact tail may have a bottom portion for contacting at least one circuit and side portions for retaining the spring contact in a slot on the bracket. The interconnection member may be a substrate having conductors on two sides for contacting the conductors on the mating surfaces of the cylinder portions. The substrate of the interconnection member may be flexible.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

FIG. 1 is an illustration of a movable body and a non-movable body of an electronic device in accordance with a first embodiment of the present invention;

FIG. 2 is a detailed illustration of a second view of the hinged member of the electronic device of FIG. 1 in accordance with a first embodiment of the present invention;

FIG. 3 is a detailed illustration of the interior of a hinged member of the electronic device of FIG. 1, showing slip rings used for electrical connectivity between the movable body and non-movable body in accordance with a first embodiment of the present invention;

FIG. 4 is a detailed illustration of the electronic device of FIG. 1, showing contact fingers on the non-movable body used to interconnect with the slip rings to establish electrical conductivity between the movable body and non-movable body in accordance with a first embodiment of the present invention;

FIG. 5(a) is a detailed illustration of the electronic device of FIG. 3 showing the slip rings, used for electrical connectivity between the movable body and non-movable body, interconnected to 3-D electrical circuits routed and arranged on the surface of the molded plastic of the movable body in accordance with a first embodiment of the present invention;

FIG. 5(b) is a detailed illustration of the movable member of FIG. 5(a) showing a span underneath the slip rings in accordance with a first embodiment of the present invention;

FIG. 6(a) is a detailed illustration of the electronic device of FIG. 1 showing spring loaded contact fingers on a printed circuit board in the non-movable body and slip rings on the hinged member in accordance with a first embodiment of the present invention;

FIG. 6(b) is an illustration of alternative embodiment of the present invention, where the slip rings are integrated into the non-movable body and the contact fingers are integrated on the hinged member in accordance with a second embodiment of the present invention;

FIG. 7 is an illustration of a disassembled electronic device of FIG. 1 featuring contact fingers on a printed circuit board in the non-movable body, and slip rings on the hinged member in accordance with a first embodiment of the present invention;

FIG. 8 is an illustration of an electronic device featuring two conductive hinge pins for conductivity between a movable body and a non-movable body in accordance with a third embodiment of the present invention;

FIG. 9 is a detailed illustration of the hinge pin of FIG. 8 in accordance with a third embodiment of the present invention;

FIG. 10 is an illustration of a movable body and a non-movable body of an electronic device in accordance with a fourth embodiment of the present invention;

FIG. 11 is a detailed illustration of the hinged member and coaxial insert in accordance with a fourth embodiment of the present invention;

FIG. 12 is another detailed illustration of the hinged member and coaxial insert in accordance with a fourth embodiment of the present invention;

FIG. 13 is a detailed illustration of a two piece coaxial insert in accordance with the present invention;

FIG. 14 is an illustration of a further embodiment of the present invention featuring a hinged member with slip rings on one side and a coaxial cavity on the other side;

FIG. 15 is a top perspective view of a hinge member in accordance with a still further embodiment of the present invention;

FIG. 16 is a bottom perspective view of the hinge member of FIG. 15;

FIG. 17 is an exploded view showing the component of the hinge member of FIG. 15;

FIG. 18 is a longitudinal cross-sectional view of the hinge member of FIG. 15;

FIG. 18A is an enlarged cross-sectional view of a portion of the view of FIG. 18; and

FIG. 19 is a transverse cross-sectional view of the hinge member of FIG. 15.

### DETAILED DESCRIPTION OF THE INVENTION

The hinged member of the present invention provides integrated electrical conductivity between a movable body and non-movable body of an electronic device through the hinged member, without the use of individual conductive wires, flexible conductive cables, electrical coaxial cable(s), bundles of wire, or combinations thereof.

The hinged member physically and electrically interconnects a movable body to a non-movable body of an electronic device. The hinged member comprises a non-conductive member having electrically conductive material integrated thereon and forming part of the hinge member. By use of this conductive material integrated within the hinged member, the hinged member provides electrical conductivity between the movable body and the non-movable body.

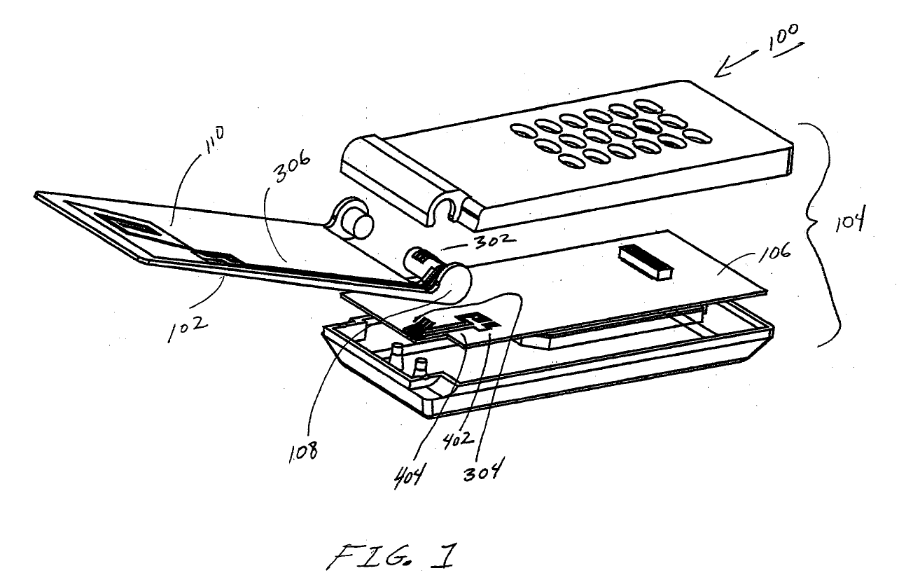

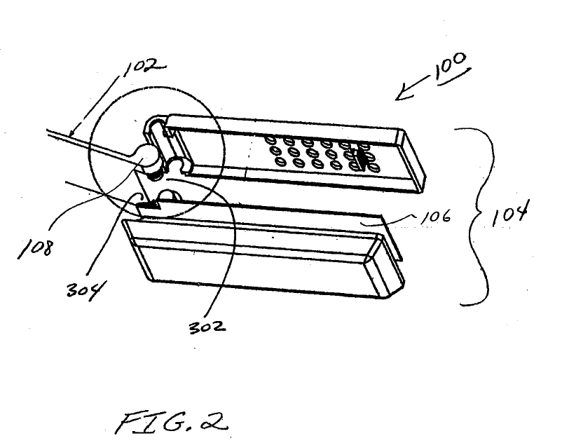

A wireless telephone device is used as a representative electronic device in the description below solely for simplicity of explanation, and is not intended to limit the scope of the invention. Referring to the drawings, FIG. 1 illustrates a wireless telephone (an electronic device) 100 featuring a movable body 102 and non-movable body 104. Movable body 102 and non-movable body 104 are interconnected by a hinge member 108. Movable body 102 includes one or more electronic circuits 110, or other electrical parts or features, e.g., an antenna. (FIG. 2 provides a depiction of FIG. 1 from a different perspective.)

Electronic circuits 110 may be fabricated directly on the movable body 102 using any methods of fabricating 3-D circuits on a substrate, e.g. a plastic substrate or may be a separate substrate mounted thereon. 3-D fabrication techniques include “applique” film techniques, photo-imaging, two-shot molding, or insert molding, and are described in detail below. These techniques are also employed to integrate the electrically conductive material on the hinged member and to interconnect the electronic circuits on the movable and non-movable bodies through the hinge. Non-movable body 104 includes a printed circuit board 106 on which electronic circuits reside. Electrical circuits on the non-movable body may also be integrated thereon by the aforementioned 3-D circuit fabrication techniques.

The insert molding process uses conductive wires, stamped metal pieces, etc. that are placed into the mold and captured by the injection molding process. The film techniques, photo imaging and two-shot molding manufacturing processes are described on (a) the MIDIA Homepage http://www.midia.org/mida2.htm, at “Manufacturing Process Descriptions,” accessed on Jun. 20, 2002, the entirety of which is incorporated herein by reference and (b) the Siemens Website R&D Homepage http://w4.siemens.deFuI/en/archiv/zeitschrift/helft1_{—}97/artike/10/index.html at “Manufacturing Technology,” accessed on Jul. 1, 2002, the entirety of which is incorporated herein by reference.

Film techniques have in common the fact that the conducting material starts out as a separate, flexible film, and then is subsequently attached to an injection-molded plastic substrate. The conductors are normally formed from copper laminate, foil, or silver conductive inks on a carrier. Common film techniques are the capture process, transfer process, and hot stamping.

The capture process utilizes pre-formed circuits on a flexible carrier which are then inserted into an injection mold. The circuits are formed by either printing conductive inks, or by selectivity etching copper-clad films. The circuit on the flexible carrier is die-cut to shape, and can be thermoformed into three dimensions before inserting it in the mold. During the molding cycle, the plastic resin is injected behind the carrier, forcing it against the outer surfaces of the mold. After the cycle is complete, the carrier with the circuit becomes an integral portion of the rigid injection-molded part. Metal-plating may be used to build up circuit thickness or provide a different metal overcoat. The circuits on the carrier can be either single or double-sided. Circuits for the capture process can either be one-sided or two sided, and can be flat or thermoformed into a three-dimensional shape.

The transfer process is a slightly different variation of the capture process. In the transfer process the flexible carrier is peeled away rather than remaining with the molded part, leaving only the circuits. In this case, the top of the circuits end up flush with the surface of the molded part which may have benefits for applications requiring sliding contacts. Only single sided circuits on the carrier can be used in this process.

Hot stamping is another common film technique which utilizes flexible copper foil coated with an adhesive, along with embossing and hot-stamping. A special embossing die is built incorporating a heated block. In this method the substrate is injection-molded prior to applying the circuit. The foil is pressed onto the plastic using the heated die and at the same time, the conductor is cut off in the shape of the embossing die to form the circuit. The remaining foil is then removed. Copper foil with other metal overcoats may be used. This is a relatively simple process, but the plastic surface where the circuit is being embossed must be relatively flat, or have a smooth, uniform contour so that the embossing die can contact the surface precisely.

As alternatives to film techniques to form 3-D circuits, photo-imaging processes use some form of light energy to define the circuits, and in most cases, an etching process to remove unwanted metal after imaging. Common photo-imaging techniques include 3-D masking, which is Applicant's preferred technique, and direct laser marking.

3-D Masking utilizes a photoresist coated onto the conductor which is then exposed to ultraviolet light through a mask. The substrate is first chemically treated in order to promote adhesion between the plastic and metal which will be plated onto it. A thin layer of copper is deposited which makes the surface conductive, followed by the application of a photoresist. The substrate is then placed into a photomask and exposed to ultraviolet light. The photomask has been designed to allow light to expose and harden the photoresist everywhere except where the circuit pattern is desired. These three-dimensional masks can be produced by machining metal or plastic, or by utilizing a process whereby a laser, controlled by a robot, creates an image on a special laser markable plastic. This plastic sheet is vacuum-formed to create the three-dimensional mask. After ultraviolet light exposure, the unhardened resist is chemically removed, leaving the underlying copper uncovered where the circuit traces are required. Copper is then electroplated to build up the desired thickness of the circuit, followed by another metal overcoat, if desired. All photoresist is then chemically removed, followed by the etching away of the thin layer of electroless copper. This leaves the plastic part with only the desired circuit pattern. This plating process is described as “semi-additive.”

There is a variation of the 3-D masking process which uses fully additive plating techniques. In this technique, the entire plastic substrate is plated with copper to the final desired thickness before the resist is applied. The photomask is designed so that the resist is exposed and hardened where the circuit traces are desired. After the unhardened resist is chemically removed, the entire thickness of copper which has been uncovered is etched away, again leaving the plastic part with only the desired circuit pattern. With this method, however, the copper traces are still coated with the hardened resist. This is chemically removed, and then electroless metal or organic overcoats can be applied. This process is described as “subtractive” processing.

Direct laser marking is another common photo-imaging technique which uses a laser beam controlled by a robot to image the pattern on the metal plated plastic part directly without the use of a mask. With this method, the entire part is plated with copper to the final desired thickness, followed by a thin layer of tin which acts as a resist to certain etchants. The laser is then used to create the image outline of the circuit paths by removing or ablating the thin layer of tin from the copper. The underlying copper is then etched away which isolates the circuit traces defined by the laser. This process generally leaves most of the non-circuit plastic surface covered with metal which can be useful for EM/URFI shielding, e.g., antennas.

A third common technique for 3-D circuit formation is two-shot molding. Two-shot molding techniques use two separate molding cycles, and usually two different plastic resins to form the part. (This type of molding is sometimes referred to as two-color or two-component molding.) This technique requires construction of different complementary mold cavities for each shot. Common two-shot molding techniques include a catalyzed resin process, a non-catalyzed process, and a two part assembly process.

The catalyzed resin process uses a plastic resin which contains a small percentage of plating catalyst. The part is designed so that the imaging is done during the molding by leaving this catalyzed resin exposed on the surface of the final part only where the circuit traces are desired. This is accomplished by creating two molds. The first shot is molded, and then inserted into the second mold. The second resin then forms the final three-dimensional features of the part. Depending on the design of the part, either the first or second shot resin may be the one containing the plating catalyst. After molding the second shot, the part is chemically treated in order to promote adhesion between the plastic and the metal which will be plated onto it. When the part is run through an electroless copper plating cycle, only the resin which contains the catalyst accepts plating and thus creates the circuit pattern. Other electroless metal overcoats can be applied if desired. Rotary molds or robotic handling may be used for the two shot molding process.

The non catalyzed process uses resins which do not contain a plating catalyst. In this technique, the first shot is molded, and then chemically treated with a catalyst before molding the second shot. The completed part is then run through the copper plating cycle, and only the resin which has been chemically treated plates to form the circuits.

Alternatively, the two part assembly process is yet another variation in which two separate parts may be molded. In this method, one part is plated in its entirety with copper, and any desired overcoats. This part is then mechanically assembled with the other non-plated second part to form the final part configuration.

Insert molded circuits are formed by using stamped or formed or die-cut conductors. The conductors are placed into features in a mold tool that is then filled with injected plastic, capturing and locating the conductors while leaving the desired portions of the conductors exposed or protruding on the surface of the molded part.

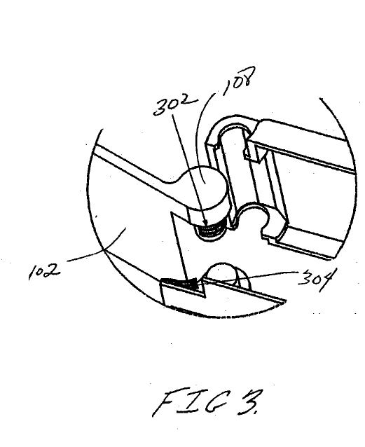

Referring to FIG. 1 and FIG. 3, electronic circuits 110 on the movable body 102 are directly interconnected to one or more slip rings 302, on a hinged member 108 of the movable body 102, by electrically conductive lines 306 formed onto the inner surface of the movable body 102 using any of the above described 3-D circuit fabrication techniques. These electrically conductive lines 306 are formed in the molded plastic of the movable body 102 to interconnect or communicate electrical signals from the electronic circuits 110 located elsewhere on the movable body 102 to the conductive slip-rings 302 or visa versa.

The slip rings 302 allow for free relative rotation of the hinged member 108, while also ensuring good electrical contact and communication between the circuitry located in both molded plastic bodies 102, 104. The metal or metal plated plastic slip rings 302 are formed using electrically conductive material(s), well known to those in the art, to enable easy installation, ensure good wear characteristics and overall excellent electrical connection properties with low resistance and low noise. The slip rings 302 can be comprised of, or plated with, copper, beryllium/copper alloys, nickel, gold, or any other conductive metal. In choosing a conductive material, the slip rings 302 and underlying molded plastic materials can, if needed, be optimized for electrical impedance control. Electrical impedance control is especially important for applications using high frequency or RF currents through the hinged areas 108.

The slip rings 302 can be stamped or plated metal conductors that can be snapped into place on the hinged member 108, such that the slip rings 302 are either on the surface of the hinged member 108 or recessed in the hinged member 108, and integrated into hinged member 108, conforming to the contours of the hinged member 108. Alternatively, the slip rings 302 may be fabricated on the hinged member 108 employing any of the above described 3-D circuit fabrication techniques. In a preferred embodiment of the present invention, each slip ring 302 has a metal thickness ranging from 0.0001 to 0.010 inches.

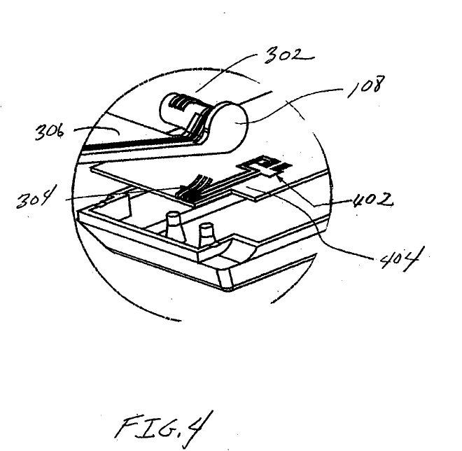

The slip rings 302 mate with, or align with, and brush against stationary contacts shown as contact fingers 304 on the non-movable body 104. See FIG. 4. In a preferred embodiment, the contact fingers 304 are spring loaded conductive bodies and physically located on the printed circuit board 106 of the non-movable body 104, as shown in FIGS. 1, 4 and 6(a), such that the contact fingers 304 are electrically connected to the circuits 402 on the printed circuit board 106 via electrical lines 404. The contact fingers 304 may be provided in a wide variety of shapes, sizes and configurations. The contact fingers 304 may be formed by stamping or plating metal conductors that can be affixed mechanically and electrically to the printed circuit board 106. Alternatively, the contact fingers 304 may be recessed in the base substrate of the non-movable body 104, using any of the above described 3-D circuit fabrication techniques, where the complementary slip rings 302, in this case, are spring loaded (while still conforming to the shape of the hinged member 108). The contact fingers 304 may be comprised of, or plated with, copper, beryllium/copper alloys, nickel, gold, or any other conductive metal, and each preferably have thickness ranging from 0.001 to 0.040 inches.

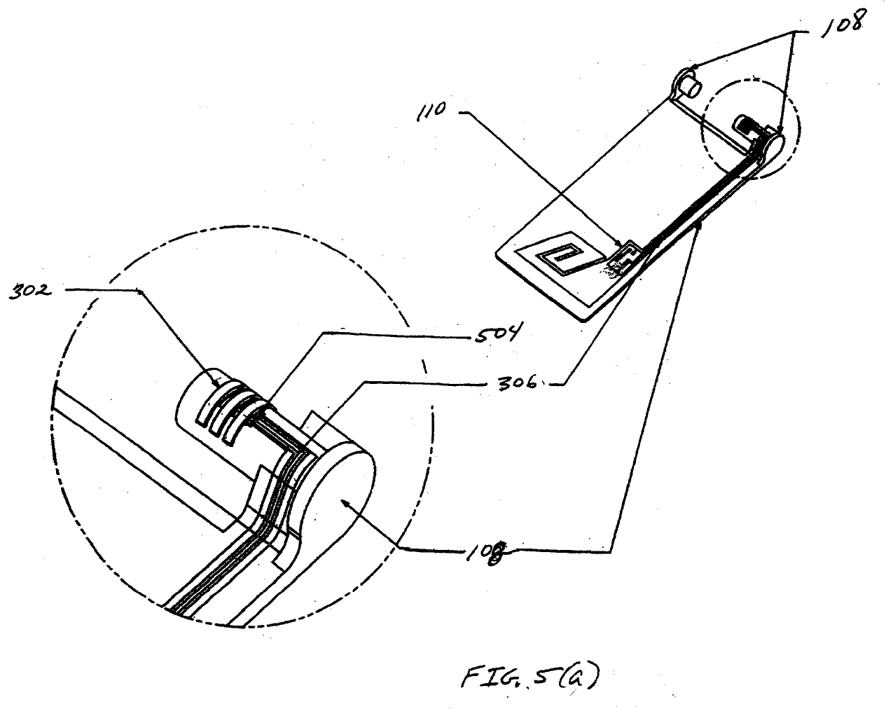

Referring to FIG. 5(a), the slip rings 302 are electronically connected to electrically conductive lines 306 (patterned using any of the 3-D circuit fabrication techniques described above). As shown in FIG. 5(b), the electrically conductive lines 502, 504 may selectively pass under a span 506, a molded recessed cavity under the slip rings 508, 510 and interconnect with a slip ring(s) of choice. For example, in FIG. 5(b) electrically conductive line 502 interconnects with slip ring 508, and electrically conductive line 504 interconnects with slip ring 510. Alternatively, the electrically conductive lines 502, 504 and the slip rings 508, 510 may be the same continuous materials, respectively, if the slip rings 508, 510 are fabricated and recessed in the hinged member 108 are described above. However, such an approach may be more costly.

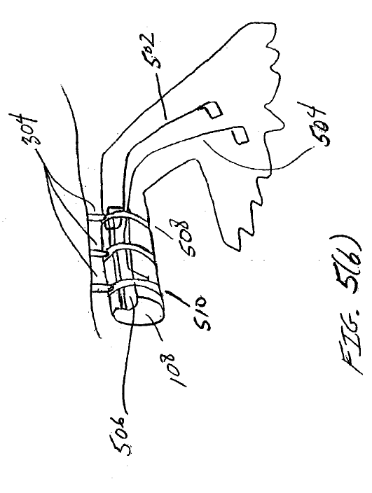

Referring to FIG. 6(b), in another alternative (second) embodiment, the contact fingers 630 may be integrated on the hinged member 108, and the slip rings 632 may be integrated in non-movable body 104, where non-movable body 104 features a recessed cavity 634.

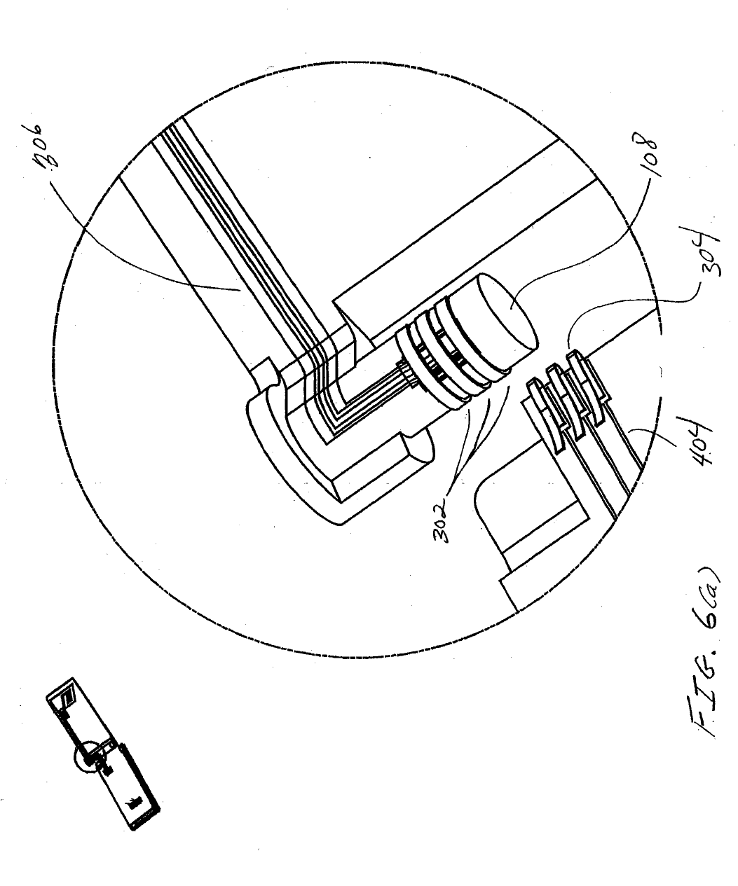

FIG. 7 provides an illustration of all of the above-described members and parts of wireless telephone 100. In particular, FIG. 7 shows the ease of connectivity of wireless telephone 100 utilizing the inventive features of the present invention. Typically the constituent bodies simply snap or press-fit together, thereby automatically electrically engaging the movable body 102 with the non-movable body 104 through the hinged member 108.

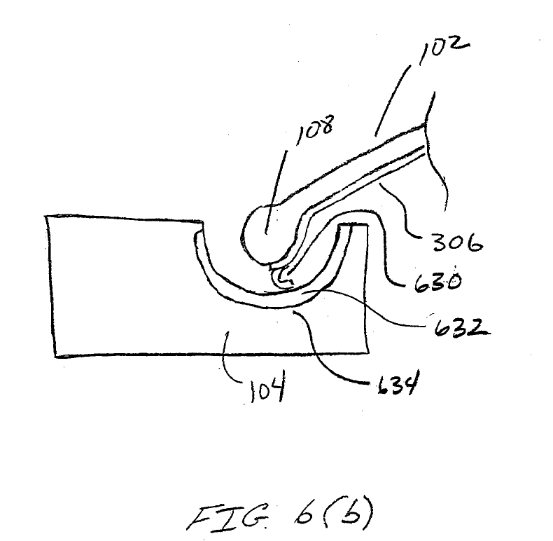

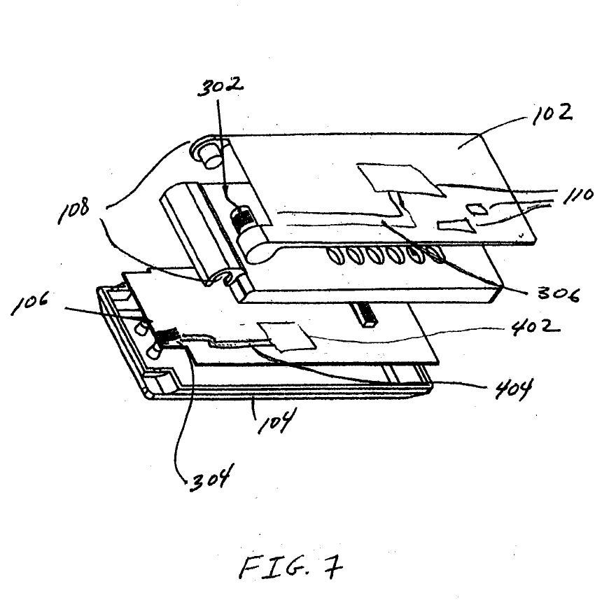

Referring to FIG. 8, as an alternative to utilizing slip rings 302, in a third preferred embodiment of the present invention, a hinge pin 812 may be used. A hinge pin 812 is most useful for applications where few electrical connections, e.g., two connections, between a movable body and a non-movable body are needed. An example of such would be a wireless flip telephone where a 2-wire microphone needs to communicate to a non-movable body. (Also see open/close contact 808.) FIG. 9 illustrates a close-up of the hinge pin 812, which interfaces with a stationary contact on a non-movable body. A hinge pin 812 may be comprised of, or plated with copper, nickel, gold, or any other conductive metal. A stationary contact to mate with the hinge pin 812 may be a contact finger or cylindrical conductive body with an inner void whereby the hinge pin 812 interfaces, or equivalent feature to receive hinge pin 812, mounted on a printed circuit board in a non-movable body.

Referring back to FIG. 8, a movable body assembly 800 of an electronic device is illustrated. Movable body assembly 800 includes a keypad member 802, and flip inner housing 804. Keypad member 802 typically contains a numeric membrane keypad for a user to dial in a number (numeric membrane not shown). Typically the numeric membrane keypad interfaces with a flexible circuit used to discern and communicate numbers corresponding to those pressed by a user on the numeric membrane keypad. A flexible circuit is typically used for this application because a flexible circuit provides a surface where wires can be soldered. Additionally, wires on the flexible circuit keypad or discrete wires, cable and connector(s) are generally needed to pass through the hinge to interconnect with circuits in a non-movable body. However, utilizing the inventive features of the present invention the flexible circuit, wires, cable, or connector(s) can be eliminated, as shown in FIG. 8. This is primarily because a flexible circuit was only needed because of the need for wiring for the conventional interconnection through the hinge. Using the slip rings 304 or hinge pin 812 as shown in this second embodiment of the present invention, the flexible circuit can be replaced with a keypad circuit 806 molded or formed/patterned directly on the substrate, where the circuit on the substrate interconnects with the slip rings 304 or hinge pin 812 via electrically conductive lines 816, similar to that of FIG. 5(b).

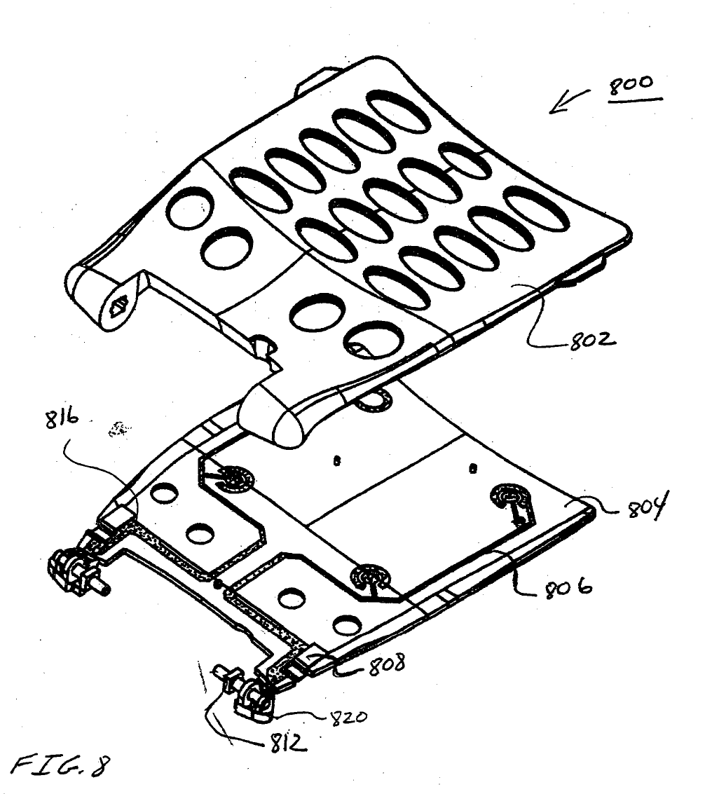

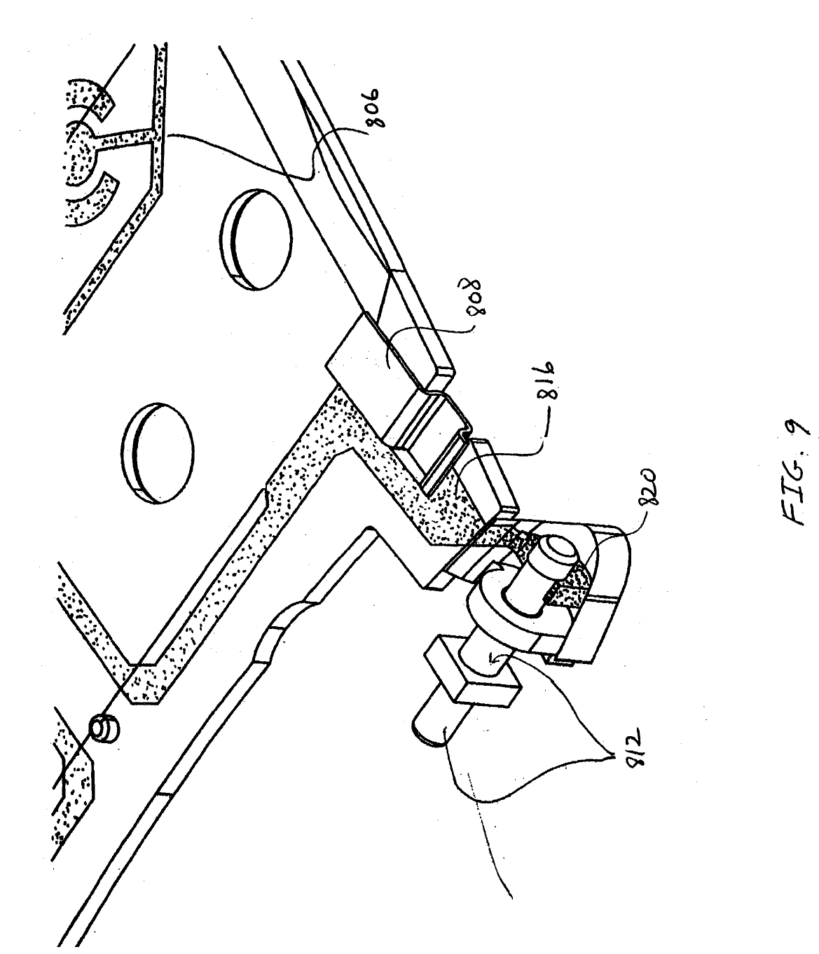

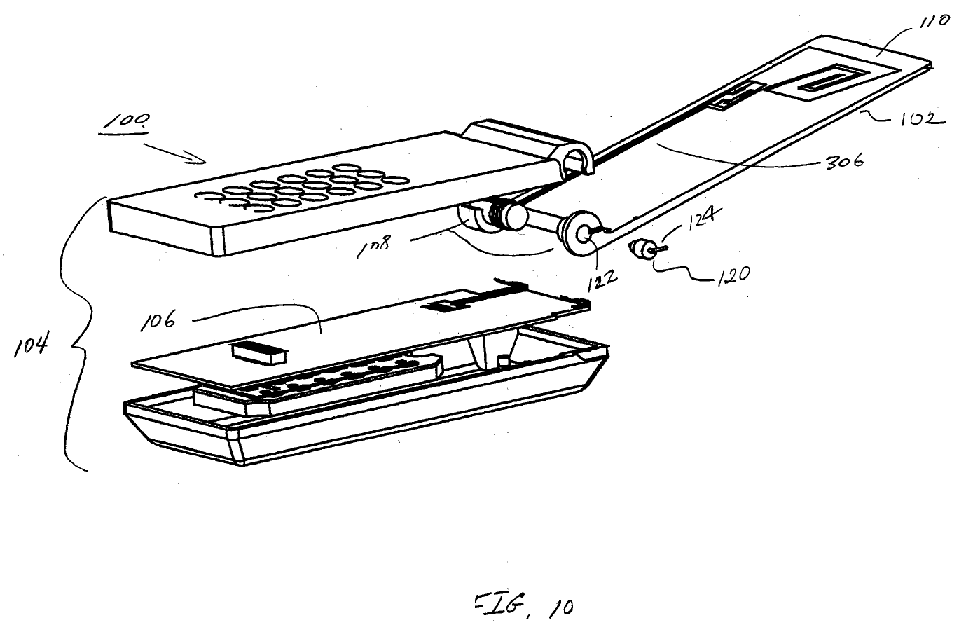

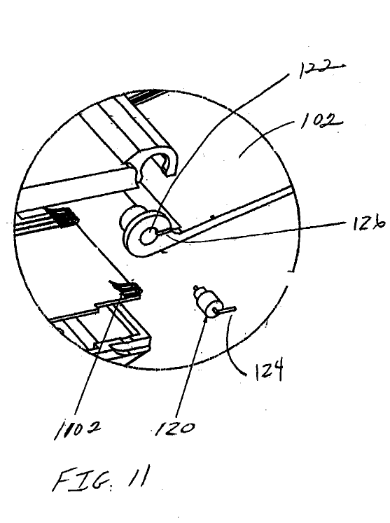

Referring to FIG. 10, in accordance with a fourth embodiment of the present invention, coaxial cable 124, or other controlled impedance low loss transmission line design, e.g, striplines, is passed through the hinged member 108, thereby establishing high speed RF coaxial connections though the hinged member 108 for purposes of controlled impedance in high frequency applications. The hinged member 108 features a coaxial insert 120 mountable in the hinged member 108. Referring to FIG. 11, the coaxial insert 120 is constructed to securely hold coaxial cable 124 therein. The coaxial insert 120 fits into a cavity 122 in the hinged member 108, as shown in FIG. 12. Preferably the coaxial cable insert 120 is a one piece assembly, where coaxial cable 124 passes through the coaxial insert 120 and along a coaxial feed 126 on the hinged member 108 to maintain electrical contact with desired components on the movable member 102. The other end of the coaxial cable 124 interconnects with a second set of stationary contacts 1102 (of FIG. 11) (similar to stationary contacts 304, described above) to provide electrical conductivity between the components in the movable member 102 and the non-movable member 104. Alternatively, as shown in FIG. 13 the coaxial insert 120 may be constructed as two pieces which mate at a rotatable interconnection 1306, where one piece 1302 of the coaxial insert 120 maintains stationary contact with the hinged member 108, and another piece 1304 of the coaxial insert 120 maintains stationary contact with the non-movable member 104. Alternative to using the coaxial insert 120, the features of the coaxial insert 122 may be molded directly into the hinged member 108.

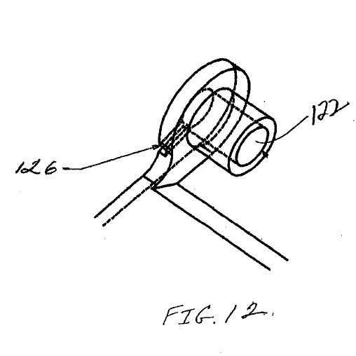

Preferably, as shown in FIG. 14, the above embodiments may be combined such that one side of a hinged member 108 may feature slip rings 302 and the other side of the hinged member 108 may feature a coaxial cavity 122 for insertion of a coaxial insert 120.

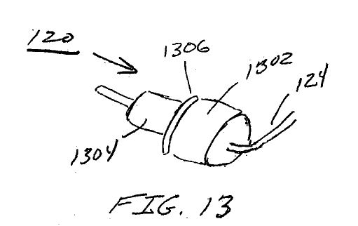

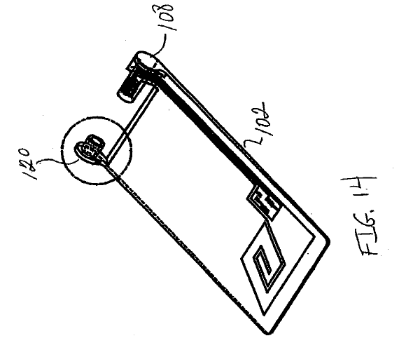

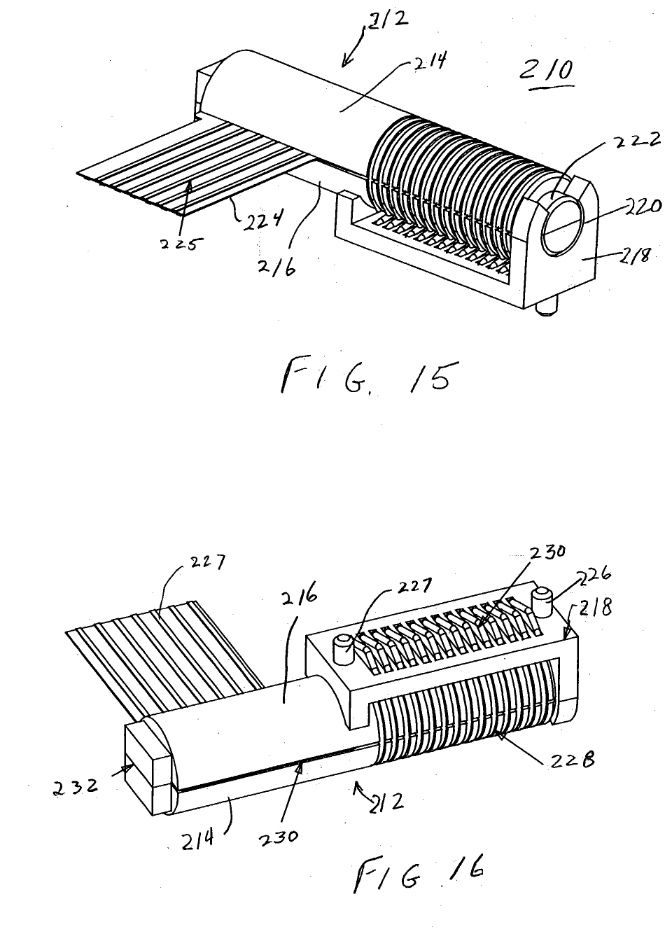

Referring to FIGS. 15 and 16 there is shown perspective views of an embodiment of a hinge member 210 in accordance with the present invention. Hinge member 210 includes a cylinder 212 which is fabricated as two half cylinder portions 214 and 216. Cylinder portion may be joined by adhesive, bonding or screws. Cylinder 212 includes a cylindrical extension 222 at a first axial end which is received in a bore 220 on a bracket 218. The other axial end of cylinder 212 includes a square or rectangular projection 232, which is arranged for attachment to a pivotable body. Bracket 218 is arranged to be mounted on a first body and allow pivoting of a second body attached to end projection 232 about an axis corresponding to the axis of cylinder 212. The hinge member 210 is arranged to interconnect at least one circuit on the first body and at least one circuit on a second body. Referring to FIG. 17 it can be seen that cylinder portions 214 and 216 are provided with circumferential grooves 238. Grooves 238 include a conductor extending within at least a portion of each groove and onto one of the mating surfaces between cylinder portions 214 and 216. In the preferred arrangement alternate ones of the grooves have conductors which extend onto the planar mating surface of cylinder portion 214 and the remaining grooves have conductors which extend onto the mating surface of cylinder portion 216. The conductors within grooves 238 need not extend completely around the circumference of the cylinder but may extend only partially around the cylinder by an amount sufficient to provide connection to contact springs 228 as will be evident. Conductors within grooves 238 and conductors 240 on the mating surface are formed using three dimensional formation techniques as indicated above. An interconnection member 224 is partially sandwiched between cylinder portions 214 and 216 and includes conductors 225 having connection pads 248 for interconnection with connection pads 242 on the mating surfaces of cylinder portions 214 and 216. It should be understood that interconnection member 224 is preferably provided with such connections on both sides to interconnect to conductors on both cylinder portions. In some applications, however, conductors may be provided on only a single side of interconnect member 224, for example, where a lesser number of connections is required. Interconnection member 224 may be a flexible substrate to permit easy mounting on a board. In the arrangement shown, one of the cylinder portions 214 is provided with locating pins 244 which pass through a corresponding bore 246 in interconnection member 224 into a bore in the other cylinder portion. Interconnection member 224 is arranged to be connected to circuits on the pivotable body by conventional techniques, for example, by attachment to a flat cable connector, by soldering, or by press connection. Groves 238 may alternately be formed as the spacing between circumferential ridges.

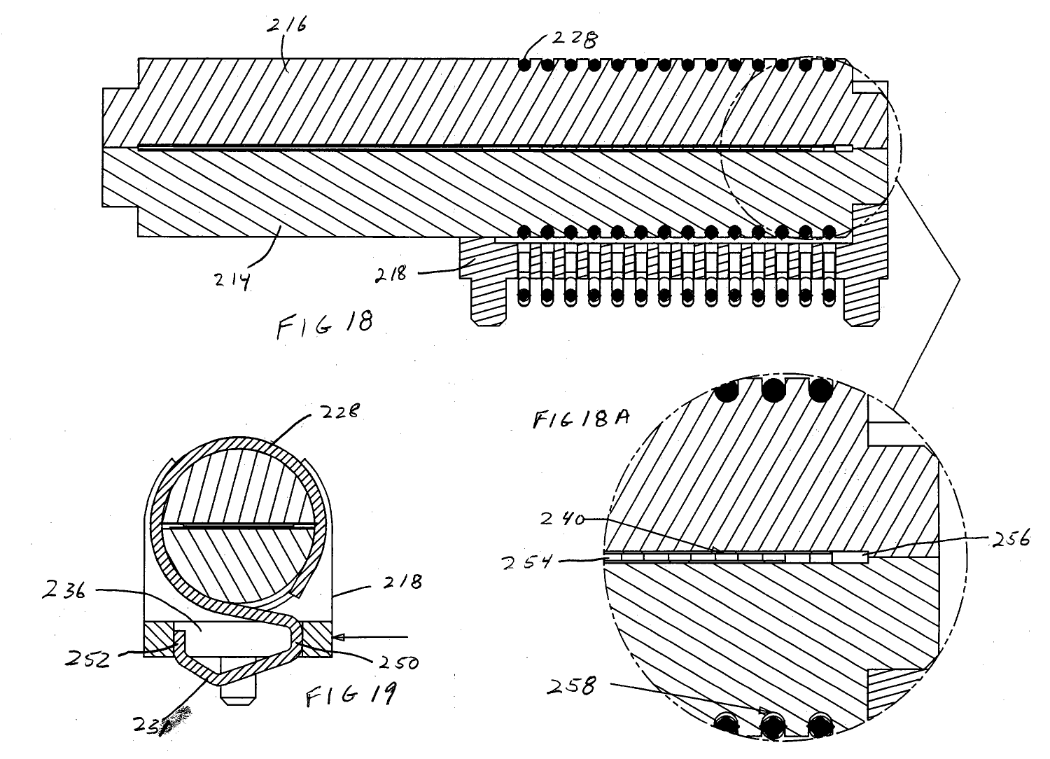

Spring contacts 228 are arranged to be received in grooves 238 and to compressively engage the conductors within the grooves to provide an electrical connection between the spring contacts 228 and the conductors within grooves 238. In the embodiment shown in FIG. 17, spring contacts 228 include a contact tail 230 which is arranged to be received in slots 236 on bracket 218. As shown in FIG. 19, the contact tail of springs 228 may include a bottom portion 231 which may engage a conductor on a printed circuit board on a first body and side portions 250 and 252 which may engage the ends of slot 236 to retain spring member 228 and cylinder 212 in position on bracket 218.

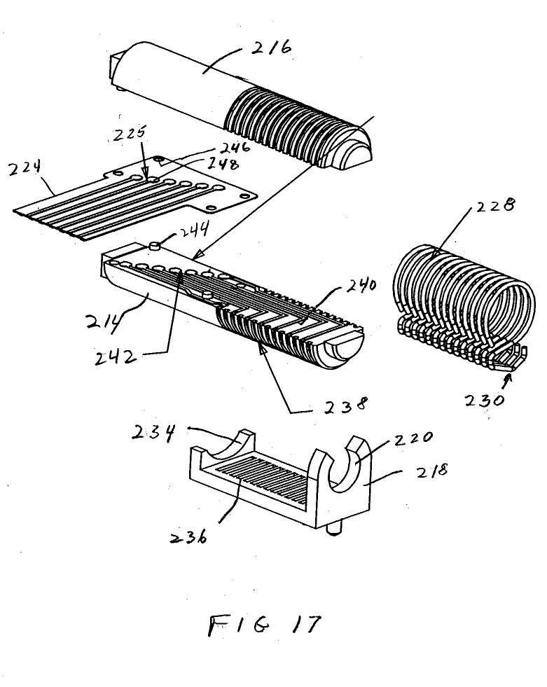

As shown in FIG. 16, the bracket 218 may include locating pins 226 and 227 for locating bracket 218, for example, on a printed circuit board and enable end portions 230 of springs 228 to engage conductors on the circuit board. Alternately, the ends of contact springs 228 may be arranged to otherwise connect to a circuit on a first body. For example, the end of contact springs 228 may comprise pins arranged to pass through and be soldered onto a printed circuit board. Referring to the cross-sectional view of FIG. 18 and the enlarged portion thereof, shown as FIG. 18A, the cylinder portions 216 and 218 may be undercut as shown at 256 so that the conductors 240 mounted on each mating surface of cylinder portions 214 and 216 are spaced from each other by a spacing 254 to prevent unintended connection therebetween. Alternately a non-conductive spacer or coating may be used.

The configuration of hinge member 210 enables fabrication of a very small hinge with many inter connections. For example, the cylinder 212 may have a diameter of 0.15 inches and length of about 0.67 inches. The embodiment illustrated has 14 grooves 238 and 14 spring contacts 228 spaced 0.020 inches on center. The spring contacts are formed of wire with a diameter of 0.010 inches. The conductors 240 on the mating surfaces have a width of 0.010 inches and spacing of 0.010 inches, while conductors 225 interconnection member 224 have twice the width and spacing.

The resultant rotating connection system of the present invention results in products with hinged members that are cheaper, more easily assembled and serviced, more reliable, easily produced and replicated in high volumes, and do not require separate wiring, cables, connectors, or other means to establish electrical connection and communication through the hinged members.

Although the present invention has been described in detail with reference to specific exemplary embodiments thereof, various modifications, alterations and adaptations may be made by those skilled in the art without departing from the spirit and scope of the invention.

We claim:

1. A hinge member arranged to provide electrical connection between electrical circuits on a first body and electrical circuits on a second body pivotably mounted to said first body, comprising:
a bracket mounted on said first body;
a cylinder having an axis arranged to be mounted on said second body and pivot therewith, said cylinder being arranged to be rotatably received in said bracket, said cylinder being formed in at least two cylinder portions having mating surfaces extending in the direction of said axis, said cylinder having a plurality of circumferential grooves and three dimensional electrical conductors in selected portions of said grooves, each said conductors extending onto at least one of said mating surfaces;
spring contacts rotatably received in at least some of said grooves and having ends extending into said bracket, said spring contact ends being arranged to connect to at least one circuit on said first body; and
at least one interconnection member received between said mating surfaces of said cylinder and arranged to interconnect said three dimensional electrical conductors to at least one circuit on said second body.

2. A hinge member as specified in claim 1 wherein said cylinder is a circular cylinder.

3. A hinge member as specified in claim 1 wherein said mating surfaces are planar surfaces.

4. A hinge member as specified in claim 3 wherein said mating surfaces are partially undercut and wherein said conductors extend onto undercut portions of said mating surfaces.

5. A hinge member as specified in claim 1 wherein said conductors in alternate ones of said grooves extend onto said mating surface of a first cylinder portion and wherein said conductors in remaining ones of said grooves extend onto said mating surface of a second cylinder portion.

6. A hinge member as specified in claim 1 wherein said cylinder is received in said bracket at a first axial end and wherein said cylinder is arranged to be mounted to said second body at a second axial end.

7. A hinge member as specified in claim 1 wherein each of said spring contacts includes a circular spring portion which is received in said grooves.

8. A hinge member as specified in claim 4 wherein each of said spring contact ends comprises a spring contact tail for connection to said at least one circuit on said first body.

9. A hinge member as specified in claim 8 wherein said contact tails have a bottom portion for contacting said at least one circuit and side portions for retaining said spring contact in a slot on said bracket.

10. A hinge member as specified in claim 1 wherein said interconnection member comprises a substrate having conductors on two sides thereof for contacting said conductors on said mating surfaces of said cylinder portions.

11. A hinge member as specified in claim 10 wherein said substrate is flexible.

12. A hinge member arranged to provide electrical connection between electrical circuits on a first body and electrical circuits on a second body pivotably mounted to said first body, comprising:
a bracket mounted on said first body;
a circular cylinder having an axis arranged to be mounted on said second body and pivot therewith, said cylinder being arranged to be rotatably received in said bracket, said cylinder being formed in two cylinder halves having planar mating surfaces extending in the direction of said axis, said cylinder having a plurality of circumferential grooves and three dimensional electrical conductors in selected portions of said grooves, each of said conductors extending onto at least one of said mating surfaces;
circular spring contacts rotatably received in at least some of said grooves and having ends extending into said bracket, said spring contact ends being arranged to connect to at least one circuit on said first body; and
at least one interconnection member comprising a substrate, having conductors on both sides thereof, received between said mating surfaces of said cylinder and arranged to interconnect said three dimensional electrical conductors to at least one circuit on said second body.
